(19) United States
(12) Patent Application Publication
(10) Pub. No.: US 2006/0254118 A1
(43) Pub. Date: Nov. 16, 2006

(54) Holder for a fishing rod and reel combination

(76) Inventor: Michael G. Warecke, Old Lyme, CT (US)

Correspondence Address: William B. Gowanlock, 16 Town Crier Lane, Madison, CT, 06443, US

(21) Appl. No.: 11/128,737

(22) Filed: May 13, 2005

(51) Int. Cl. A01K 97/10

(52) U.S. Cl. 43/21.2

(57) ABSTRACT

A holder to secure a fishing rod and reel combination. The holder secures the rod and reel combination such that the reel, even if disassociated from the rod, cannot be disassociated from the holder.

### FIELD OF THE INVENTION

The present invention relates generally to fishing equipment and more specifically to a holder for a fishing rod having a reel mounted thereon (i.e., fishing rod and reel combination.)

### BACKGROUND

Fishing equipment, particularly rods and reels, have become extremely expensive. As such, rods and, particularly, reels have become the targets of thieves.

One particularly tempting setting for a thief is when the rod and reel combination is unattended during transport or storage. While it is possible to disassemble a rod and reel combination for more secure transport or storage, many anglers find this undesirable, as it can lead to excessive wear and tear on the mechanical components that secure the reel to the rod or can result in increased setup time. Therefore, many anglers desire to transport or store their rods and reels in combination.

Rod and reel combinations, however, are long with awkwardly protruding reels. As a result, without a storage system they are generally laid on large flat surfaces, such as benches or decks on boats or in the beds of a pickup trucks, or across supports, such as seats in boats or cars. While some of these storages may be secure, many are not. Additionally, when stored in this manner, the rods, and the reels attached thereto, are subject to damage from, for example, being stepped on, sat on, grabbed for support, or inappropriately moved.

Rod holders have been developed to hold a rod and reel combination for transport or storage. One type of rod holder is a tube into which a portion of a rod, generally the handle, is placed. This type of rod holder is typically attached to a structure, such as a truck bumper or boat bimini, such that a rod placed therein extends upward out of the holder, being held in the holder by gravity. It is not uncommon to see multiple such holders attached to a truck's bumper or a boat's bimini with each holder having a rod, with a reel attached thereto, extending generally vertically therefrom.

Unfortunately, when stored in this manner, the rods, or more particularly the reels attached thereto, are subject to theft by the rod and reel combination being merely plucked from the holder when the truck or boat is left unattended. What is needed in the art is a more secure holder that deters such theft.

### SUMMARY OF THE INVENTION

This invention is a holder for a fishing rod and reel combination. The holder secures the rod and reel combination such that the reel, even if disassociated from the rod, cannot be disassociated from the holder.

These and other features, aspects, and advantages of embodiments of the present invention will become apparent with reference to the following description in conjunction with the accompanying drawings. It is to be understood, however, that the drawings are designed solely for the purposes of illustration and not as definitions of the limits of the invention.

### BRIEF DESCRIPTION OF THE DRAWINGS

FIG. 1 is a top view of the holder in the open position ready to receive a fishing rod and reel combination.

FIG. 2 is a sectional view of the holder shown in FIG. 1 taken along line 2-2.

FIG. 3 is a top view of the holder in the closed position.

FIG. 4 is a sectional view of the holder shown in FIG. 3 taken along line 4-4, which is the same line as line 2-2 depicted in FIG. 1.

FIG. 5 is a side view of the holder depicting the longitudinal insertion of a rod and reel combination.

FIG. 6 is a side view of the holder with a rod and reel combination in a stored position within the holder.

FIG. 7 is a top view of the holder with a rod and reel combination positioned within the holder. The main housing portion of the reel has been removed for clarity.

FIG. 8 is an exploded view of the components of the holder.

FIG. 9 is a side view of a second embodiment of the holder depicting the rotational insertion of a rod and reel combination.

FIG. 10 is a top view in the area of the slot shown in FIG. 9 taken along line 10-10 in the open position.

FIG. 11 is a top view of the holder with a flared top.

FIG. 12 is a top view of a plurality of holders mounted on a structure.

### DETAILED DESCRIPTION

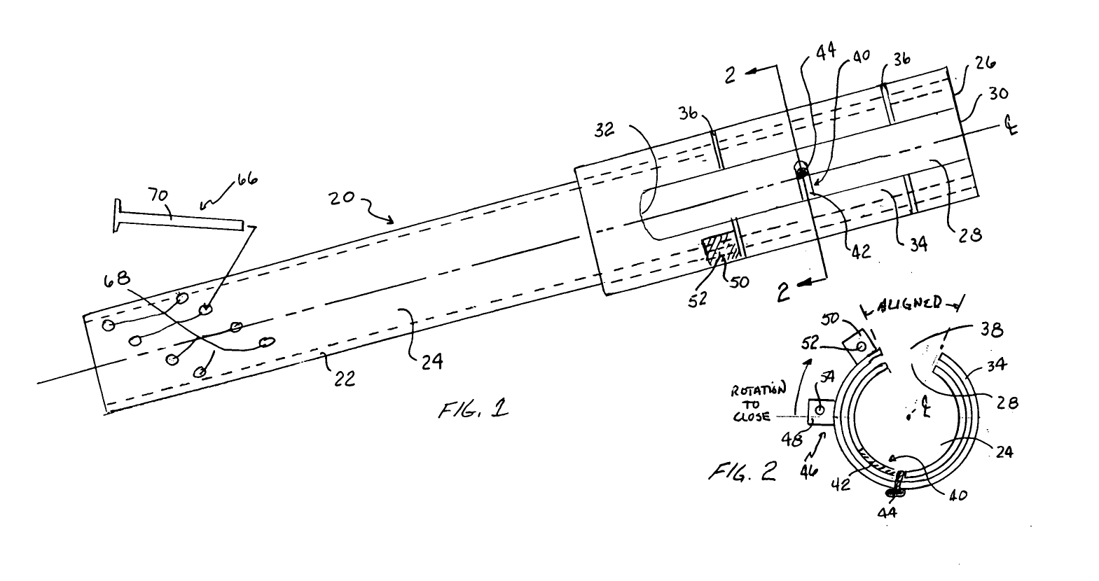

As shown in FIG. 1, the holder, generally referred to by reference number 20, includes a body 22 that defines a passage 24 with a passage opening 26. The body 22 also defines a body slot 28 having a body slot opening 30 with a bottom 32. The passage opening 26 and the body slot opening 30 are coincident.

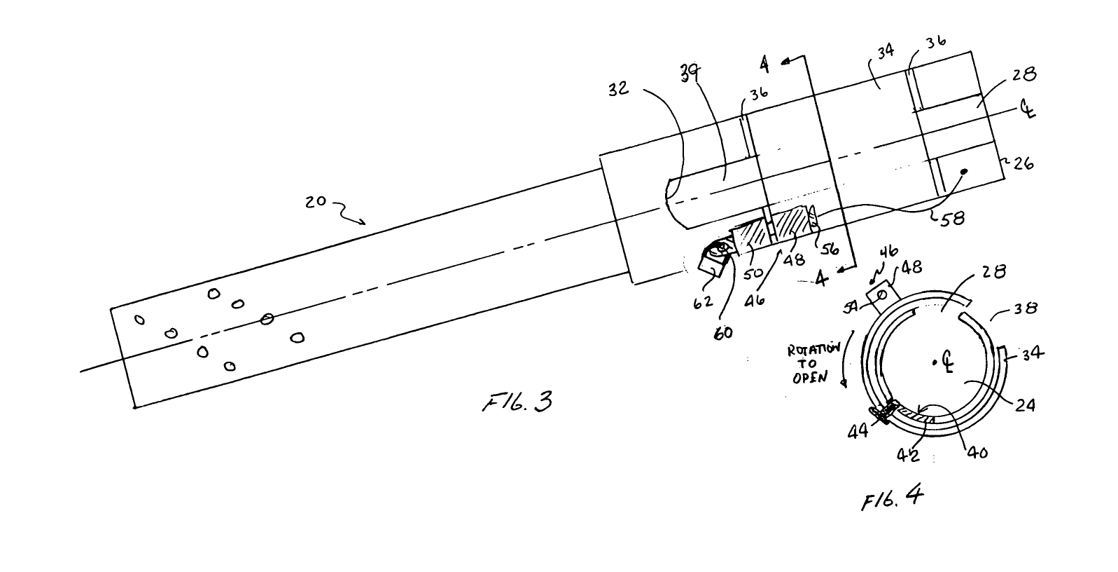

The holder 20 further includes a sleeve 34 associated with the body 22. Referring to FIGS. 1 and 3, the sleeve 34 is positioned in a rabbet 36 along the body slot 28 between the bottom 32 of the body slot 28 and the passage opening 26.

The sleeve 34 moves in the rabbet 36 from an open position (FIG. 1) to a closed position (see FIG. 3). The body 22 is in the shape of a tube and the sleeve 34 has a complementary shape (a common axis).

More specifically as shown in FIG. 2, the sleeve 34 has a sleeve slot 38. When the sleeve 34 is in the open position, the sleeve slot 38 is aligned with the body slot 28 (see dotted lines). Optimally, the sleeve slot 38 has at least the width as the body slot 28. As shown in FIG. 4, when the sleeve 34 is in the closed position, the sleeve slot 38 and the body slot 28 are no longer aligned. As shown in FIG. 3, the sleeve 34 in the closed position defines a hole 39.

Referring to FIGS. 1, 2 and 4, the movement of the sleeve 34 from the opened to the closed position is controlled by a stop 40, comprising a slit 42 and a pin 42. When the sleeve 34 is in the open position (FIG. 2), the pin 44 abuts one end of the slit 42, which aligns the sleeve slot 38 and the body slot 28. When the sleeve 34 is in the closed position (FIG. 4), the pin 44 may abut the other end of the slit 42 to assist in positioning the sleeve 34 to define the hole 39 and may also register a latch 46 (FIG. 3.)

Referring to FIG. 3, the sleeve 34 can be fixed in the closed position by the latch 46. As shown in FIG. 2, the latch 46 is comprised on a pair of blocks 48, 50, each having a through bore 52, 54, respectively. As shown in FIG. 2, when the sleeve 34 is in the open position, the bores 52, 54 are not registered. As shown in FIG. 4, when the sleeve is in the closed position the bores 52, 54 are registered. As shown in FIG. 3, when the bores 52, 54 are registered, a pin 56, which may be attached to the holder 20 by a cable 58, can be inserted through the bores. The pin 56 may also have a bore 60 through the protruding end that may accept a lock 62, such as a padlock.

Referring to FIG. 1, the holder 20 can also include one or more butt supports 66. Each butt support 66 is comprised of a pair of aligned holes 68 (only one hole of a pair shown) through which a pin 70 may be inserted. The holes 68 are positioned on the body 22 on the opposite side of the bottom 32 from the sleeve 34. To make the butt support 66 adjustable, a sequence of paired aligned holes 68 is provided. In one aspect, the pairs of aligned holes 68 form a spiral pattern. This type of non-linear alignment of the aligned holes 68 relative to the length of the holder 20 allows for finer distance adjustment gradations between the butt support 66 and the bottom 32, as pairs of aligned holes do not interfere one with the other (e.g., overlap or be so close as to present a structural problem).

Referring to FIG. 5, a fishing rod and reel combination 72 can be longitudinally inserted into the holder 20. A fishing rod and reel combination 72 includes a rod 74 and a reel 76. The rod 74 includes a handle 78 having a fore grip 80 and a butt 82 connected by a reel seat 84. The rod 74, as shown, has a butt 82 that is quite long. As those skilled in the art will appreciate, the length of the butt 82 is dependent upon the type of rod 74 and can be quite long to almost nonexistent (in some cases the bitter end of the butt is at the reel seat, such as in a fly fishing handle.) Extending outwardly from the fore grip 80 is a blank 86.

The reel 76 includes a stand 88 and a main housing 90 connected by a shank 92. The depicted reel 76 is a spinning reel, but other reels, such as casting, are of a similar design.

In a fishing rod and reel combination 72, the stand 88 of the reel 76 is coupled to the handle 78 in the reel seat 84. Most reel seats 84 are designed to removably accept the stand 88. As depicted, the reel seat 84 is comprised of a fixed tab 94 proximate the fore grip 80 and a movable tab 96 proximate the butt 82. The moveable tab 96 in a spinning rod and reel rig, which is secured about the stand 88 by a ring 98 rotating on threads.

Referring to the orientations provided in FIG. 5, typically the handle 78 has a diameter that is greater than the diameter of the blank 86. The diameter of the handle 78 is greater than the width of the stand 88. The stand 88 has a width greater than the width of the shank 92. Also, the stand 88 has a length greater than the length of the shank 92.

Continuing with FIG. 5, with the sleeve 34 in the open position, the fishing rod and reel combination 72 is inserted longitudinally butt 82 first into the passage 24 of the holder 20 through the passage opening 26. Continuing with FIGS. 5 and 6, the butt 82 end travels down the passage 24 and the shank 92 is aligned with the body slot opening 30, The shank 92 is of sufficient height and the body and sleeve slots 28, 38 of sufficient width to permit the shank 92 to traverse the body slot 28 towards the bottom 32 positioning the stand 88 of the reel 76 within the passage 24 and the main housing 90 of the reel outside the holder 20. Additionally, the body slot 28 need not be sufficiently wide to allow the handle 78 to enter the passage 24 through the body slot.

As the shank 92 traverses the body slot 28 towards the bottom 32, the shank 92 passes the sleeve 34 placing the rod and reel combination 72 is a stored position. Referring to FIG. 7, with the rod and reel combination 72 in the stored position, the sleeve 34 is rotated from the open position to the closed position, thereby defining the hole 39 through which the shank 92 passes. The sleeve 34 in the closed position is associated with the body slot 28 such that the cross section of the hole 39 is smaller than the cross section of the stand 88. As a result, the stand 88 cannot pass through the hole 39.

While the sleeve 34 in FIG. 7 is depicted as completely across the width of the body slot 28 thereby defining the hole 39 that appears to have a continuous perimeter, this is not a requirement of the invention. As those skilled in the art will appreciate, the sleeve 34 need not fully cross the width of the body slot 28 to define a hole 39 through which the stand 88 cannot be passed.

When the fishing rod and reel combination 72 is within the holder 20 in the stored position (FIGS. 6 and 7), the portion of the handle 78 within the passage 24 of the holder 20 is considered to be within a handle portion of the passage. The butt 82 may have its bitter end rest on the pin 70 of the butt support 66. If this is the case, ideally the pin 70 of the butt support 66 is positioned within the holder 20 such that the shank 92 is proximate the bottom 32, with at least a majority of the weight of the rod and reel combination 72 being transferred to the holder 20 through the butt and not the shank. This will also reduce damage to the shank 92 from riding on the bottom 32 of the holder 20.

It is, however, a matter of design choice as to how much of the handle 78 is within the holder 20, which may be at least a portion up to the entire handle. For example as shown in FIGS. 6 and 7, some of the fore grip 80 of the handle 78 can extend out of the passage opening 26. Also, some of the butt portion 82 may extend out of the other end of the holder 20 (not shown). Generally, the reel seat 84, including any mechanism that allows for the release of the stand 88 from the reel seat, should be within the holder 20. Generally, none of the blank 86 will be within the holder 20.

Where the fore grip 80 projects out of the holder 20 through the passage opening 26 when the rod and reel combination 72 is in the stored position within the holder 20, the handle portion begins at the passage opening 26 coincident with the body slot opening 30. As the body slot 28 is shorter than the handle portion, the body slot is coincident with only a portion of the handle portion. Additionally, the body slot 28 can have a width, which may be variable, that does not permit the handle 78 to pass through.

Referring to FIG. 8, the holder 20 includes the body 22 which defines the passage 24 and the body slot 28. The rabbet 36 (see FIGS. 1 and 3) is made by fixing (friction fitting with an adhesive) on the body 22 a collar 100, then positioning on the body 22 the sleeve 34 that rides on the collar 100. A keeper 102 is then fixed on the body 22 (friction fitting with an adhesive) to define the balance of the rabbet 36. The keeper 102 prevents the removal of the sleeve 34, thus it should be secured to the body 22 anticipating the attempted forced removal of a fishing rod and reel combination 72 from its stored position in the holder 20. Also, similar design considerations should be considered when designing the sleeve 34. The abutting structure of a rabbet 36 assists in deterring the removal of a rod and reel combination 72 from the holder 20 by tampering with the sleeve 34. A trim piece 104 can then be slid over the body 22, if desired.

It should be appreciated, that this is but one method of construction. It should also be appreciated that the appearance of the holder 20 can be changed by selecting, for example various thicknesses for the collar 100, sleeve 34, keeper 102, and trim piece 104. It is possible by selecting appropriate thicknesses to achieve a holder 20 with generally parallel sides, and not the step configuration depicted in FIG. 1.

A good material for the body 22 is PVC tubing. Use of this material provides a liner which does minimal, to no, damage to the handle or reel shank of the rod and reel combination. The collar 100, sleeve 34, keeper 102 and trim piece 104 may be made from a metal, such as aluminum. All the materials should be suitable for the environment in which the holder 20 will be used. This is particularly important if use in a salt water environment is anticipated.

Additionally, while a tubular body 22 has been shown, the invention should not be considered limited to a holder 20 of a circular cross-section.

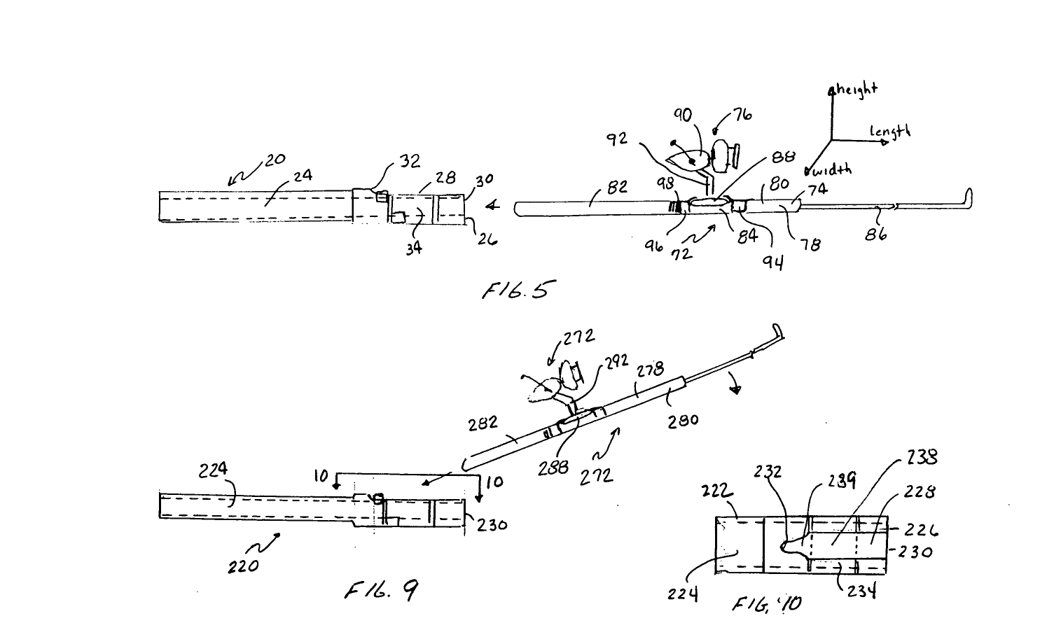

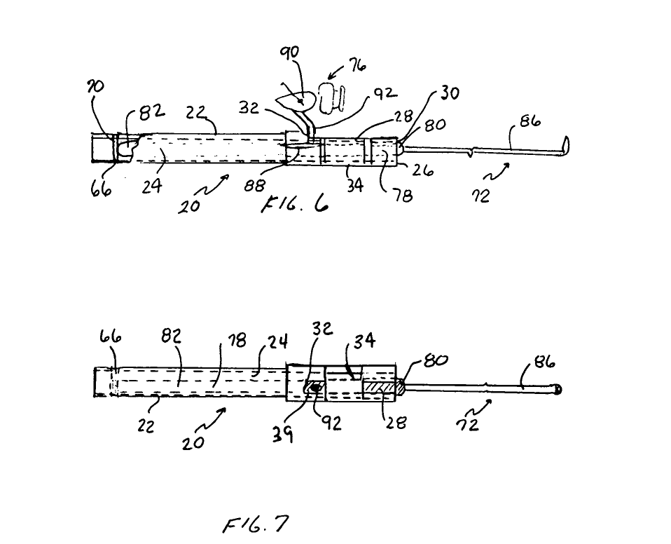

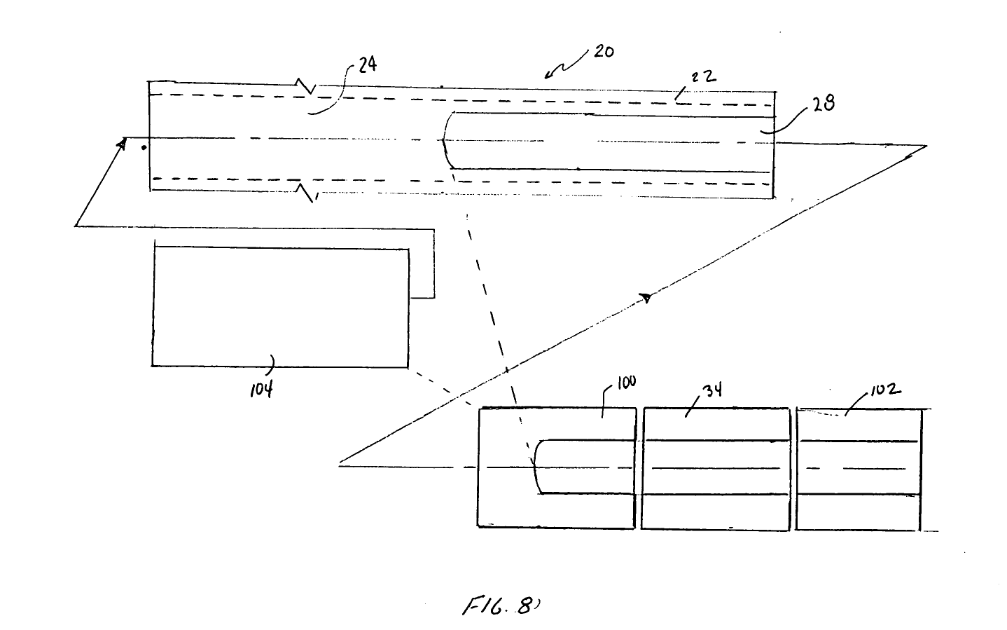

A second embodiment of the holder 220 (like elements with the first embodiment given the same reference number preceded by a “2”) is depicted in FIGS. 9 and 10. In this embodiment, the fishing rod and reel combination 272 is rotated butt 282 first into the holder 220 through the body slot 228. The sleeve slot 238 may have a width that will permit the handle 280 to pass through. Unlike the prior embodiment, the body slot 228 and the handle portion do not necessarily coincidently begin at their coincident passage opening 226 and body slot opening 230. In fact, if the fore grip 280 of the handle 278 will not project out of the passage opening 226, the passage opening need not be sized to accept the handle 278, as depicted in the previous embodiment. Similarly to the first embodiment, the hole 239 created with the sleeve 234 in the closed position prevents the removal of the stand 288 of the reel 276, which is positioned in the handle portion of the passage 224 of the holder 220.

Referring to FIG. 10, the body slot 228 may be stepped (i.e., may not have generally parallel sides). As shown, the body slot 228 has a segment having a width to permit the handle 278 to enter the passage 224, but toward the bottom 232 has a segment having a different width, which is narrowed, that may permit only the shank 292 to traverse the body slot and reach, or be positioned proximate to, the bottom.

It should be understood that generally the sleeve slot 238 when associated with a segment of the body slot 228 should cooperate to maximize the use of the body slot.

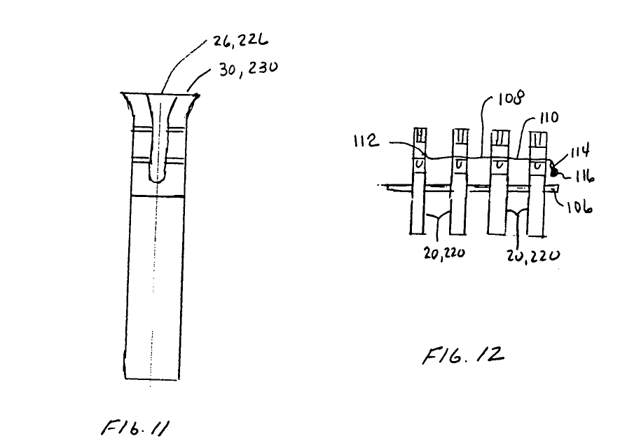

Continuing with FIG. 11, the passage openings 26, 226 and/or body slot openings 30, 230 can be flared to better accept the fishing rod and reel combination 72, 272. Flaring of the openings 26, 30, 226, 230 decreases the precision of the alignment required to insert the handle 78, 278 and shank 92, 292, particularly in the first embodiment. Additionally, the sleeve slots may also be flared.

FIG. 12, depicts a plurality of holders 20, 220 mounted to a structure 106 such as a bracket, truck bumper, boat bimini, or boat structure. Ideally, the holders 20, 220 are mounted such that a fishing rod and reel combination 72, 272 positioned in the holder 20, 220 extends generally upward. As discussed above, the majority of the blank 86, 286 will not be in the holder 20, 220. As a result when the holder 20, 220 is positioned on, for example, a truck bumper, the blank may be in a driver's line of view, but not the holder 20, 220.

A common lock 108 may be provided. A common lock 108 is one that allows for a single lock to be removed, allowing one or more holders 20, 220 to be opened. A common lock 108 may be accomplished by putting a cable 110, with a stop 112 on one end and a loop 114 on the other, through the bore 60 of each pin 56 (see FIG. 3) and then putting a single lock 116, such as a padlock, in the loop.

While there has been illustrated and described what is at present considered to be preferred and alternative embodiments of the claimed invention, it will be appreciated that numerous changes and modifications are likely to occur to those skilled in the art. It is intended in the appended claims to cover all those changes and modifications that fall within the spirit and scope of the claimed invention.

What is claimed is:

1. A holder for securing a rod and reel combination comprising:
a body defining a passage with a passage opening, and a body slot with a body slot opening coincident with the passage opening and a bottom, the passage having a handle portion dimensioned to accept at least a portion of a fishing rod handle, the body slot coincident with at least a portion of the handle portion, the body slot dimensioned to pass a shank of a reel coupled to a reel seat of the handle and extending outwardly therefrom, and
a sleeve associated with the body between the bottom and the passage opening and movable relative to the body slot between an open position and a closed position, the sleeve in the open position permitting the shank to traverse the body slot past the sleeve, and in the closed position trapping the shank between the bottom and the sleeve in an hole having a cross-section through which a stand of the reel affixed to the shank and positioned within the passage cannot pass.

2. The holder of claim 1 wherein the body slot has a width that requires longitudinal insertion of the fishing rod handle into the passage.

3. The holder of claim 1 wherein the sleeve rides in a rabbet.

4. The holder of claim 1 further comprising a latch mounted on the holder for securing the sleeve in the closed position.

5. The holder of claim 4 wherein the latch is comprised of a pair of blocks movable one to the other, each having a through bore, and the in the closed position the bores being registered such that a pin can be inserted through the bores.

6. The holder of claim 1 further comprising a butt support associated with the body for supporting a butt of a fishing rod handle positioned within the holder.

7. The holder of claim 6 wherein the butt support is positioned relative the bottom permitting the shank to be proximate the bottom so at least a majority of the weight of the rod and reel combination is transferred to the holder by the butt support.

8. The holder of claim 1 wherein the butt support is adjustable.

9. The holder of claim 8 wherein the adjustment of the butt support is accomplished by a plurality of aligned holes in the body.

10. The holder of claim 9 wherein the plurality of aligned holes is in the pattern of a spiral.

11. The holder of claim 1 wherein the body slot has a width that allows the rotational insertion of the fishing rod handle into the holder.

12. The holder of claim 11 wherein the body slot is stepped.

13. The holder of claim 1 wherein the open end of the body slot has a flare.

14. The holder of claim 13 wherein the open end of the sleeve slot has a flare.

15. The holder of claim 1 further comprising a stop for aligning the sleeve slot with the body slot in the open position.

16. A multiple fishing rod and reel holder comprising:
a structure,
a plurality of fishing rod holders including a body defining a passage having a open end, and a slot with an open end coincident with the passage open end and a bottom, the passage having a handle portion dimensioned to accept at least a portion of a fishing rod handle, the slot coincident with at least a portion of the handle portion, the slot dimensioned to pass a shank of a reel coupled to a reel seat of the handle and extending outwardly therefrom, and a sleeve associated with the body and movable relative to the slot between an open position and a closed position, the sleeve in the open position permitting the shank to traverse the slot, and in the closed position trapping the shank between the bottom and the sleeve in a hole having a cross-section through which a stand of the reel affixed to the shank and positioned within the passage cannot pass mounted on the structure.

17. The multiple fishing rod holder of claim 18 wherein each holder has a latch for securing the sleeve in a closed position, and further including a common locking system for securing the latches.

18. The method of storing a fishing rod and reel combination comprising the steps of:
obtaining a fishing rod and reel combination having a reel with a shank and the rod with a butt;
placing the fishing rod and reel combination butt first in a holder wherein the holder includes a body defining a passage having a open end, and a slot with an open end coincident with the passage open end and a bottom, the passage having a handle portion dimensioned to accept at least a portion of a fishing rod handle, the slot coincident with at least a portion of the handle portion, the slot dimensioned to pass a shank of a reel coupled to a reel seat of the handle and extending outwardly therefrom, and a sleeve associated with the body and movable relative to the slot between an open position and a closed position, the sleeve in the open position permitting the shank to traverse the slot, and in the closed position trapping the shank between the bottom and the sleeve in a hole having a cross-section through which a stand of the reel affixed to the shank and positioned within the passage cannot pass.

19. The holder of claim 18 wherein in the step of placing the fishing rod and reel combination in the holder, the body slot has a width that requires longitudinal insertion of the fishing rod handle into the passage of the holder.

20. The holder of claim 18 wherein in the step of placing the fishing rod and reel combination in the holder, the body slot has a width that allows the rotational insertion of the fishing rod handle into the holder.
